(19) United States
(12) Patent Application Publication
(10) Pub. No.: US 2015/0046138 A1
(43) Pub. Date: Feb. 12, 2015

(54) VEHICULAR SIMULATION TEST GENERATION

(71) Applicant: International Business Machines Corporation, Armonk, NY (US)

(72) Inventors: Allon ADIR, Kiryat Tivon (IL); Alex GORYACHEV, Haifa (IL); Tamer SALMAN, Haifa (IL); Gil SHUREK, Haifa (IL)

(73) Assignee: International Business Machines Corporation, Armonk, NY (US)

(21) Appl. No.: 13/960,808

(22) Filed: Aug. 7, 2013

(51) Int. Cl. G06F 17/50

(52) U.S. Cl. CPC G06F 17/5095
USPC 703/8

(57) ABSTRACT

A method comprising using at least one hardware processor for: providing a plurality of behavioral models of vehicular components; providing a plurality of simulated vehicular components; providing a model of interaction between at least some of said vehicular components; and generating a simulation test for said vehicular components by defining continuous behavioral functions for said plurality of behavioral models and for said plurality of simulated vehicular components, wherein each of said continuous behavioral functions comprises a superimposition of a finite number of continuous functions each having a finite number of parameters, and wherein at least some of said continuous behavioral functions interrelate in accordance with said model of interaction.

### BACKGROUND

Today's vehicles are immensely computerized. Computerized devices are naturally error-prone, and thus require a testing phase in which the errors should be discovered. Vehicular components, such as sensors, actuators and processing units are commonly tested in a simulated environment before finalizing the production of a vehicle. The goal of the testing is to ensure component and system fidelity. The cost of an error in a vehicular component may be enormous, and its consequences may be disastrous. For example, an undetected error in a component of a vehicle may cause the injury of a person relying on the designated behavior of that particular component and/or related components. Additionally, such an error, whether it is of hardware or software, may be expensive to fix, as patching such an error often requires the call-back of the vehicle. For this reason, much of the computerized environment of today's vehicle may be regarded as a “critical system”.

Many of today's vehicle simulation systems create a simulated environment based on historical measurements collected from field testing of the same or a related type of vehicle. Additionally or alternatively, in some vehicle simulation systems the simulated environment is created manually, by a user who feeds the stimuli and essentially composes a desired environment.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with an embodiment, a method comprising using at least one hardware processor for: providing a plurality of behavioral models of vehicular components; providing a plurality of simulated vehicular components; providing a model of interaction between at least some of said vehicular components; and generating a simulation test for said vehicular components by defining continuous behavioral functions for said plurality of behavioral models and for said plurality of simulated vehicular components, wherein each of said continuous behavioral functions comprises a superimposition of a finite number of continuous functions each having a finite number of parameters, and wherein at least some of said continuous behavioral functions interrelate in accordance with said model of interaction.

There is further provided, in accordance with an embodiment, a computer program product for vehicular test generation, the computer program product comprising a non-transitory computer-readable storage medium having program code embodied therewith, the program code executable by at least one hardware processor to: provide a plurality of behavioral models of vehicular components; provide a plurality of simulated vehicular components; provide a model of interaction between at least some of said vehicular components; and generate a simulation test for said vehicular components by defining continuous behavioral functions for said plurality of behavioral models and for said plurality of simulated vehicular components, wherein each of said continuous behavioral functions comprises a superimposition of a finite number of continuous functions each having a finite number of parameters, and wherein at least some of said continuous behavioral functions interrelate in accordance with said model of interaction.

In some embodiments, each of said continuous behavioral functions is defined by multiple time segments, wherein said superimposition of the finite number of continuous functions is different for at least some of the multiple time segments.

In some embodiments, the parameters are selected from the group consisting of: a frequency, an amplitude, a linear slope, a base, a texture, a “from” time, a “to” time and a duration.

In some embodiments, the method further comprises executing said simulation test by feeding said continuous behavioral functions into said plurality of behavioral models and into said plurality of simulated vehicular components.

In some embodiments, the method further comprises recording readings of at least some of said plurality of behavioral models in response to said executing.

In some embodiments, said vehicular components are selected from the group consisting of: vehicular sensors, vehicular actuators and vehicular processing units.

In some embodiments, at least some of said continuous behavioral functions represent normal behavior of at least some of said vehicular components.

In some embodiments, at least some of said continuous behavioral functions represent abnormal behavior of at least some of said vehicular components.

In some embodiments, at least some of said continuous behavioral functions represent erroneous behavior of at least some of said vehicular components.

In some embodiments, the method further comprises using said at least one hardware processor for biasing at least some of said continuous behavioral functions, wherein the biasing is based on user input.

In some embodiments, the method further comprises using said at least one hardware processor for biasing at least some of said continuous behavioral functions, wherein the biasing is based on a model of testing knowledge.

In some embodiments, the method further comprises using said at least one hardware processor for superimposing noise on at least some of said continuous behavioral functions.

In some embodiments, the method further comprises using said at least one hardware processor for biasing said noise, wherein the biasing is based on user input.

In some embodiments, the method further comprises providing a plurality of physical vehicular components, wherein said feeding of the continuous behavioral functions is made also into said plurality of physical vehicular components.

In some embodiments, the program code is further executable by said at least one hardware processor to execute said simulation test by feeding said continuous behavioral functions into said plurality of behavioral models and into said plurality of simulated vehicular components.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 shows a flowchart of a method for generating a vehicular test;

FIG. 2 shows a block diagram of a system for generating one or more vehicular tests; and

FIG. 3 shows an exemplary topology of an in-car network

### DETAILED DESCRIPTION

A method, a system and a computer program product for vehicular simulation test generation are disclosed herein. In some embodiments, the vehicle type for which a simulation test is generated in an automotive.

The simulation test generation, in accordance with present embodiments, is based on harnessing multiple behavioral models of vehicular components as well as multiple simulated vehicular components. Optionally, the simulation test generation may also utilize one or more physical vehicular components which are operatively coupled to a computerized device carrying out the test generation and/or executing the test.

Advantageously, the test may be generated by defining continuous behavioral functions for the behavioral models, the simulated vehicular components and optionally the physical vehicular components. These continuous behavioral functions are constructed in accordance with a defined interrelation between at least some of the behavioral models, the simulated vehicular components and optionally the physical vehicular components. In order to define the interrelation, a model of interaction may be provided. The model may prescribe, for example, how a lower or a higher gear is shifted to based on engine RPM. As another example, the model may define an association between engine RPM and gear on one hand, and wheel speed on the other hand. Those of skill in the art will recognize that the interrelation (or “interaction”) between different vehicular components is known; accordingly, the model of interaction may be constructed by translating these known interrelations into a mathematical model embodied in a program code.

In some embodiments, at least some of the continuous behavioral functions are each characterized by a finite set of parameters. These parameters may include, for instance:

For sinus functions: Base, amplitude, frequency, texture (e.g. smooth, sharp) and/or the like;

For linear functions: “From” value; “to” value, in time (duration) and/or the like;

For constant functions: Value; and

For “bursts”: Amplitude, duration and/or the like.

For each such parameter, a start time may be defined.

The simulation test generated in accordance with present embodiments may be executed (also “run”) by any suitable computing device. The execution may be logged, namely—readings of at least some of the behavioral models may be recorded, for example in a non-volatile memory, for display and/or analysis. The execution of the simulation test may include a feeding of the continuous behavioral functions into the behavioral models and/or into the simulated vehicular components.

The vehicular components for which the test is generated may include, for example, sensors, actuators and/or processing units. Exemplary sensors may include an engine RPM (revolutions per minute) sensor, a WSS (wheel speed sensor), an engine temperature sensor, an ambient temperature sensor, etc. Exemplary actuators may include a throttle actuator, a gear actuator, etc. Exemplary processing units may include an ECU (engine control unit), a CCU (cruise control unit), a TCU (transmission control unit), a lock control, a window control, an airbag control, an entertainment control, headlights control, ABS (anti-lock breaking system) control, etc.

The term “simulated vehicular component”, as referred to herein, may relate to a mathematical model structured to mimic the behavior and operation of a physical vehicular component. The simulated vehicular component may receive input, act upon the input and provide output as if it were a physical vehicular component. This allows testing the simulated vehicular component itself.

The term “behavioral model”, as referred to herein, may relate to a software model designed to receive input and provide output similar to the actual vehicular component it simulates. However, a simulated vehicular component is only intended to allow interaction with other components of a simulated system, for the sake of completeness of the system; the simulated vehicular component itself may not be tested in the simulation. Additionally or alternatively, a behavioral model may mimic the behavior of the vehicle's operator, namely—its driver.

The term “physical vehicular components”, as referred to herein, may relate to an actual vehicular component which may be operatively coupled to a computing device executing the simulation test. This configuration is often referred to as “hardware in-the-loop” (HIL).

The continuous behavioral functions may each represent normal, abnormal or erroneous behavior of the pertinent vehicular component. Normal behavior is the typical behavior exhibited by that component during normal driving of the vehicle. For example, it is normal that all wheels indicate forward movement when the gearbox is in a forward gear. Abnormal behavior, on the other hand, is an atypical but nonetheless possible behavior of a component. For example, abnormal behavior may be one wheel spinning slower than the other wheels, for instance as a result of this wheel engaging a puddle. Lastly, erroneous behavior is one which clearly results from an error in the pertinent sensor, actuator and/or control unit. For example, a zero RPM reading when the engine is running is clearly the result of an error in the RPM sensor.

In some embodiments, a user interface is provided, for enabling a user to bias at least some of the continuous behavioral functions. The biasing, for example, may be in order to alter the behavior of the functions, in order to simulate various driving conditions, environmental conditions, errors and/or the like. The biasing may be based on testing knowledge either stored in a memory and/or manually input by the user.

In some embodiments, noise may be superimposed on at least some of the continuous behavioral functions. The noise may be randomly and automatically created and/or created manually by the user. This noise may be representative of occasional reading errors and/or of certain inaccuracies which are inherent to the various vehicular components. The noise may be biased by the user, for example in order to increase or decrease the frequency, amplitude and/or or any other parameter of the noise.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a hardware processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

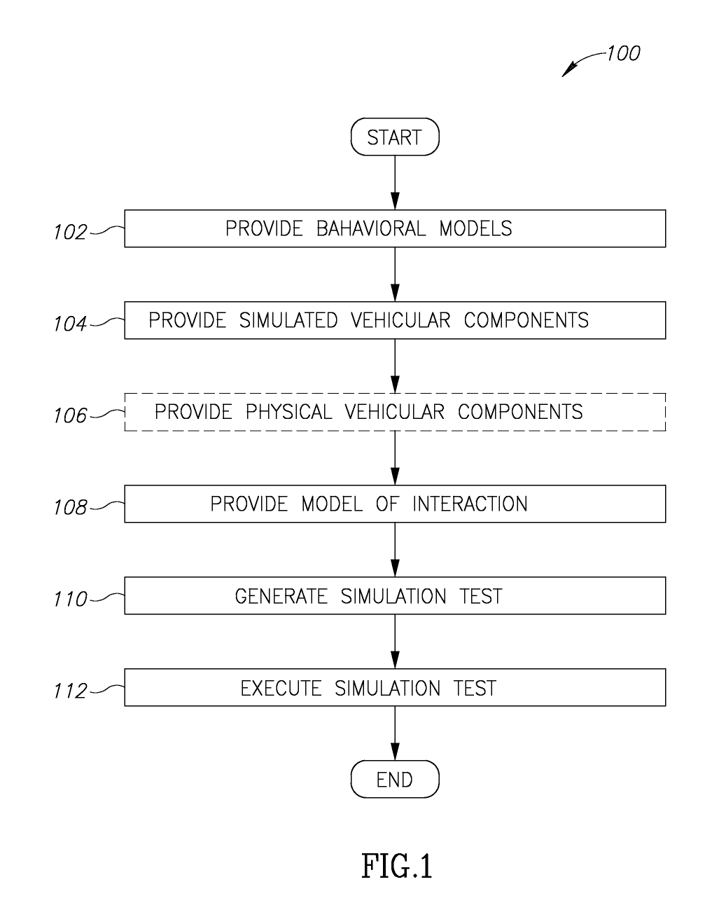

Reference is now made to FIG. 1, which shows a flowchart of a method 100 for generating a vehicular test, in accordance with an embodiment. Method 100 may be executed by any suitable computing device.

In a step 102, a plurality of behavioral models of vehicular components is provided. In a step 104, a plurality of simulated vehicular components is provided. In an optional step 106, one or more physical vehicular components are provided, and operatively coupled to the computerized device executing method 100.

In a step 108, a model of interaction between at least some of the vehicular components is provided. This model dictates how the operation of multiple components is orchestrated, whether under normal or abnormal driving conditions.

Then, in a step 110, a simulation test is generated based on the provisioning of steps 102, 104 and optionally 106, in conjunction with the model of interaction provided in step 108. The simulation test may be embodied as program code usable, for example, by technical personnel in the automotive industry who desire to test components of a vehicle either before, during or after production.

In a step 112, which is optionally carried out by a different entity than the one generating the simulation test, the simulation test may be executed, to actually test and verify the various vehicular components participating in the test.

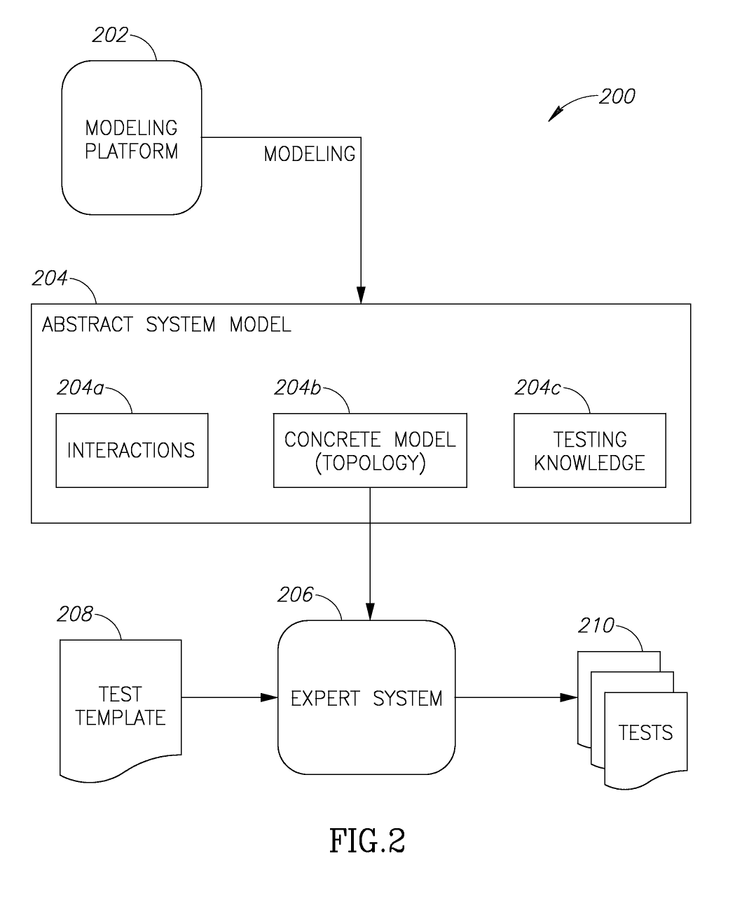

Reference is now made to FIG. 2, which shows a block diagram of a system 200 for generating one or more vehicular tests. System 200 may include a modeling platform 202, operable by a user to construct behavioral models of various vehicular components. The models created by modeling platform 202 may be fed to an abstract system model 204 responsible for orchestrating the operation of multiple vehicular components. Accordingly, abstract system model 204 may include data pertaining to interactions 204a between vehicular components, a topology 204b of vehicular components inside a typical vehicle, and/or testing knowledge 204c. Each of abstract system model 204, interactions 204a and a topology 204b may be a data library provided with certain initial data. The user may change the data included in these libraries or add new data, as desired.

Abstract system model 204 is then usable by an expert system 206 for allowing a user to input one or more variables into a test template 208 based on the abstract system model, for generating one or more tests 210.

Advantageously, system 200 is configured to represent a computerized in-car network, which includes multiple vehicular components, as a transaction-based system. As known in the art, transaction-based systems process information by dividing the processing tasks into individual, indivisible operations, referred to as “transactions”. Each transaction must succeed or fail as a complete unit; it cannot remain in an intermediate state. Hence, in a test of an in-car network simulated using a transaction-based system, each of the vehicular components either passes of fails the test.

Test template 208, in accordance with present embodiments, may be structured by a user using a template language which specifies, at a high level, various desired test stimuli.

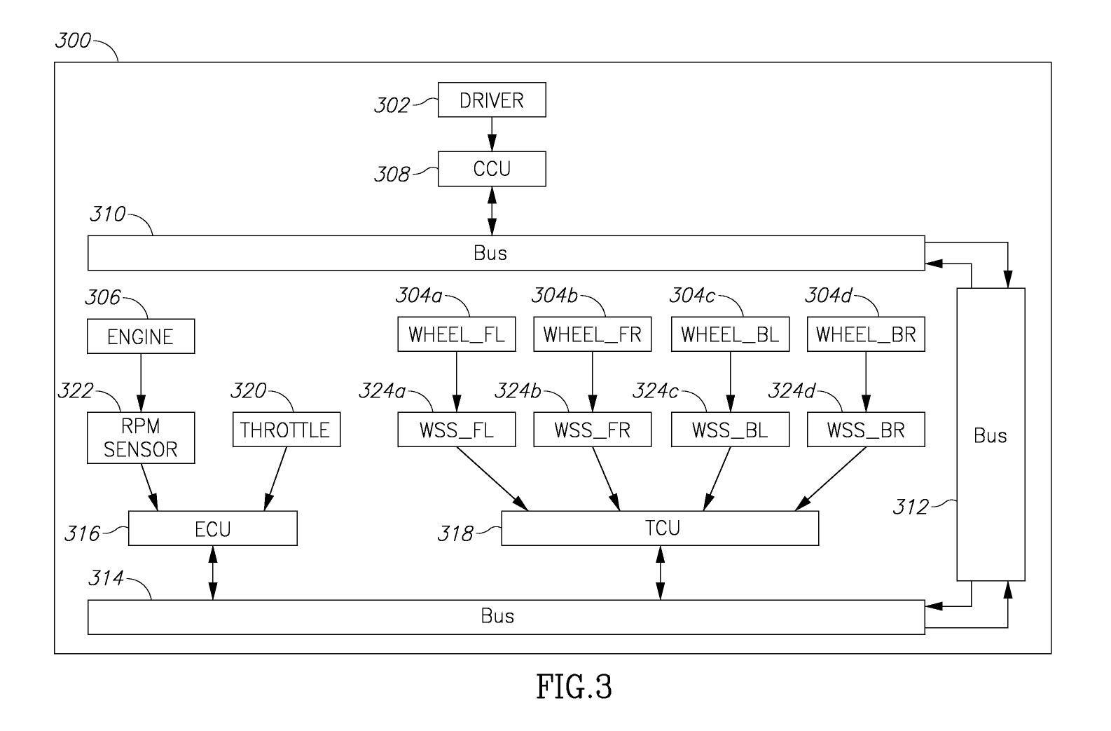

Reference is now made to FIG. 3, which shows an exemplary topology of an in-car network 300, in accordance with present embodiments. In network 300, a driver 302, four wheels 304a-d and an engine 306 may be behavioral models defining how these components operate when a system is simulated. The behavioral models may enable the receipt of instructions of a continuous nature, which instruct the pertinent component how to behave as time progresses.

Network 300 is further shown with a CCU 308 connected to a series of CAN (controlled area network) buses 310, 312 and 314, the last of which is connected to an ECU 316 and a TCU 318. ECU 316 may be connected to a throttle 320 influencing the operation of engine 306. The engine's operation is monitored by an RPM sensor 322. Finally, TCU 318 may be connected to the four wheels 304a-d and their WSSs 324a-d, respectively.

The following example demonstrates various interaction types between components of network 300:

RPM sensor 322 may measure the RPM of engine 306. RPM sensor 322 sends a packet with the measurement to ECU 316. ECU 316 places the packet on CAN bus 314. The packet is read by TCU 318. TCU 318 sends a control command to the gear to shift to a higher gear. A secondary participant of this interaction is the four WSSs 324a-d, which should give measurements that roughly correspond to the RPM measurement.

Further in this example, driver 302 presses a set button of CCU′ 308 and switches it to “on” state. This happens while WSSs 324a-d are sending packets corresponding to the speed that is about to be set as the cruising speed by CCU 308. A secondary participant of the interaction is RPM sensor 322, which should give measurements that roughly correspond to the measurements received from WSSs 324a-d.

WSSs 324a-d may send measurement packets to bus 314, which show a speed different than the cruising speed. CCU 308 reads these packets from bus 310 and sends a packet to ECU 316, through bus 314, to open/close throttle 320 accordingly.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising using at least one hardware processor for:
providing a plurality of behavioral models of vehicular components;
providing a plurality of simulated vehicular components;
providing a model of interaction between at least some of said vehicular components; and
generating a simulation test for said vehicular components by defining continuous behavioral functions for said plurality of behavioral models and for said plurality of simulated vehicular components,
wherein each of said continuous behavioral functions comprises a superimposition of a finite number of continuous functions each having a finite number of parameters, and
wherein at least some of said continuous behavioral functions interrelate in accordance with said model of interaction.

2. The method according to claim 1, wherein each of said continuous behavioral functions is defined by multiple time segments, wherein said superimposition of the finite number of continuous functions is different for at least some of the multiple time segments.

3. The method according to claim 1, wherein the parameters are selected from the group consisting of: a frequency, an amplitude, a linear slope, a base, a texture, a “from” time, a “to” time and a duration.

4. The method according to claim 1, further comprising executing said simulation test by feeding said continuous behavioral functions into said plurality of behavioral models and into said plurality of simulated vehicular components.

5. The method according to claim 4, further comprising recording readings of at least some of said plurality of behavioral models in response to said executing.

6. The method according to claim 1, wherein said vehicular components are selected from the group consisting of: vehicular sensors, vehicular actuators and vehicular processing units.

7. The method according to claim 1, wherein at least some of said continuous behavioral functions represent normal behavior of at least some of said vehicular components.

8. The method according to claim 1, wherein at least some of said continuous behavioral functions represent abnormal behavior of at least some of said vehicular components.

9. The method according to claim 1, wherein at least some of said continuous behavioral functions represent erroneous behavior of at least some of said vehicular components.

10. The method according to claim 1, further comprising using said at least one hardware processor for biasing at least some of said continuous behavioral functions, wherein the biasing is based on user input.

11. The method according to claim 1, further comprising using said at least one hardware processor for biasing at least some of said continuous behavioral functions, wherein the biasing is based on a model of testing knowledge.

12. The method according to claim 1, further comprising using said at least one hardware processor for superimposing noise on at least some of said continuous behavioral functions.

13. The method according to claim 12, further comprising using said at least one hardware processor for biasing said noise, wherein the biasing is based on user input.

14. The method according to claim 1, further comprising providing a plurality of physical vehicular components, wherein said feeding of the continuous behavioral functions is made also into said plurality of physical vehicular components.

15. A computer program product for vehicular test generation, the computer program product comprising a non-transitory computer-readable storage medium having program code embodied therewith, the program code executable by at least one hardware processor to:
provide a plurality of behavioral models of vehicular components;
provide a plurality of simulated vehicular components;
provide a model of interaction between at least some of said vehicular components; and
generate a simulation test for said vehicular components by defining continuous behavioral functions for said plurality of behavioral models and for said plurality of simulated vehicular components,
wherein each of said continuous behavioral functions comprises a superimposition of a finite number of continuous functions each having a finite number of parameters, and
wherein at least some of said continuous behavioral functions interrelate in accordance with said model of interaction.

16. The computer program product according to claim 15, wherein each of said continuous behavioral functions is defined by multiple time segments, wherein said superimposition of the finite number of continuous functions is different for at least some of the multiple time segments.

17. The computer program product according to claim 15, wherein the parameters are selected from the group consisting of: a frequency, an amplitude, a linear slope, a base, a texture, a “from” time, a “to” time and a duration.

18. The computer program product according to claim 15, wherein the program code is further executable by said at least one hardware processor to execute said simulation test by feeding said continuous behavioral functions into said plurality of behavioral models and into said plurality of simulated vehicular components.

19. The computer program product according to claim 15, wherein said vehicular components are selected from the group consisting of: vehicular sensors, vehicular actuators and vehicular processing units.

20. The computer program product according to claim 15, wherein said feeding of the continuous behavioral functions is made also into a plurality of provided physical vehicular components.
